(19) United States
(12) Patent Application Publication
(10) Pub. No.: US 2013/0083182 A1
(43) Pub. Date: Apr. 4, 2013

(54) LENS UNIT AND CAMERA MODULE FOR ENDOSCOPE

(71) Applicant: Ryo KITANO, Kanagawa (JP)

(72) Inventor: Ryo KITANO, Kanagawa (JP)

(73) Assignee: Fujifilm Corporation, Tokyo (JP)

(21) Appl. No.: 13/584,402

(22) Filed: Aug. 13, 2012

(30) Foreign Application Priority Data
Sep. 30, 2011 (JP) 2011-216678
Sep. 30, 2011 (JP) 2011-216679

(51) Int. Cl. G02B 7/04; H04N 5/225

(52) U.S. Cl. 348/76; 359/699; 359/700; 348/E05.026

(57) ABSTRACT

A lens unit for an endoscope includes a movable lens. A rotatable cam shaft is disposed to extend in parallel with an optical axis direction. A support device is engaged with the cam shaft, for supporting the movable lens. A cam device is disposed between the cam shaft and the support device, for moving the movable lens in the optical axis direction in response to rotation of the cam shaft. A housing is provided. A first housing cavity is defined in the housing, for containing the movable lens. A second housing cavity is defined in the housing, for containing the cam shaft. An intermediate channel is formed between the first and second housing cavities, contains the support device, and includes a pair of channel surfaces, opposed to one another, formed by machining, for guiding the support device. A black surface is formed on the support device in black dyeing.

### BACKGROUND OF THE INVENTION

1. Field of the Invention

The present invention relates to a lens unit and a camera module for an endoscope. More particularly, the present invention relates to a lens unit of which parts can have precise sizes suitable for use in an endoscope, and also production can be efficiently performed by raising yield of an assembly of such parts, and a camera module for endoscope.

2. Description Related to the Prior Art

An electronic endoscope used widely in the medical field for diagnosis and treatment of a body of a patient. The endoscope has an elongated tube, a head assembly or tip device, and a camera module. The camera module is incorporated in the head assembly, receives object light from a body cavity, and causes a display panel to display an image of the body cavity.

JP-A 2002-058635 and JP-A 2009-294540 disclose examples of the camera module having a lens system and a lens moving mechanism for changing a focal length of the lens system. The focal length can be set for one of standard imaging and telephoto imaging. The camera module includes a lens unit and a detection unit combined together. Also, the lens unit includes a driving device for moving at least one movable lens/lens group (lens optics) in an optical axis direction to change the focal length.

JP-A 2002-058635 discloses a driving device of cam shaft type, in which a camshaft rotates to shift a lens moving device in the optical axis direction. JP-A 2009-294540 discloses a driving device of direct drive type, in which an actuator of a shape memory alloy is controlled electrically to shift the lens moving device in the optical axis direction. The direct drive type has a shortcoming in that only one movable lens/lens group can be moved. In contrast, the cam shaft type can move a plurality of the movable lenses/lens groups discretely, because cam grooves can be two or more and the lens moving devices can be two or more for driving the movable lenses/lens groups.

Precision of sizes of the relevant parts is an important problem irrespective of selection of the driving method, as the camera module has such a small size as 7×4×15 mm. Specifically in the cam shaft type, a problem arises in precision of contact surfaces of the lens moving device movable in the optical axis direction inside a housing. If a space between the lens moving device and guide surfaces of the housing is small, the lens moving device will not move readily with low operability. If a motor for rotating the cam shaft is incorporated in the head assembly of the elongated tube, the cam shaft can be rotated with sufficient torque. There is no serious problem if a clearance space is rather small between the assembled parts. However, it is very difficult to incorporate a motor in the head assembly of the elongated tube for rotating the cam shaft, because the camera module for the endoscope is characterized today in that a diameter of the elongated tube is preferably decreased for reducing physical stress to the body. In the structure where the motor is incorporated in a proximal handle and a wire transmits torque of the motor to the cam shaft, it is impossible sufficiently to transmit the torque to the cam shaft. Failure in the movement of the lens moving device occurs particularly if a space between the lens moving device and the guide surfaces is small.

If a space between the lens moving device and the guide surfaces is enlarged in view of higher operability, the movable lens/lens group is very likely to shake, to cause image blur within an image frame in the course of variable magnification. It is difficult to drive the movable lens/lens group at a low torque because the movable lens/lens group moves with an inclination due to the shake. It will be impossible to move the lens moving device mechanically according to the seriousness of the problem.

In the cam shaft type, the cam shaft is parallel with the optical axis direction. The lens moving device is engaged with the cam shaft, and thus is disposed to extend for both areas of the cam shaft and the optical axis. The housing for supporting the lens moving device has an area for sliding and guiding the lens moving device inside the housing. Precision in working the guide surfaces must be kept in a range for the designed size. For example, the housing has such a form of a length of 15 mm that two curved portions with diameter of 4 mm and 3.2 mm are arranged in a lateral direction. An intermediate channel must be formed in the housing for interconnecting a first housing cavity for the lens and a second housing cavity for the shaft, and must have a height of a distal opening of 1 mm, an opening width of the distal opening of 1.5 mm and a depth of 10 mm or less. Also, the guide surfaces of the intermediate channel and a contact surface of the lens moving device must have a width of 1 mm and a depth of 10 mm, and have as high precision as plus or minus 3 microns for their flatness. The precision of plus or minus 3 microns is nearly the highest precision available according to normally used machining in the mechanical field. In a factory to produce the lens unit, finished products of the housing and the lens moving device are measured discretely, so as to find combinations of those in a condition of the precision higher than a tolerable value. Accepted combinations are assembled selectively and used commercially. This is a complicated production which causes a drop of the yield of production seriously, or a proportion of the number of the accepted products per the number of the created products.

Black dyeing is generally used for parts in the lens unit for preventing flare or scatter. There arises a problem of creating unevenness in the precision of the sizes due to the black dyeing, which has been found by reconsidering relevant elements and their features in connection with the suitable precision.

### SUMMARY OF THE INVENTION

In view of the foregoing problems, an object of the present invention is to provide a lens unit of which parts can have precise sizes suitable for use in an endoscope, and also production can be efficiently performed by raising yield of an assembly of such parts, and a camera module for endoscope.

In order to achieve the above and other objects and advantages of this invention, a lens unit for an endoscope includes a movable lens. A rotatable cam shaft is disposed to extend in parallel with an optical axis direction of the movable lens. A support device supports the movable lens on the cam shaft movably in the optical axis direction. A cam device is disposed between the cam shaft and the support device, for moving the movable lens in the optical axis direction in response to rotation of the cam shaft. A housing is provided. A first housing cavity is defined in the housing, for containing the movable lens. A second housing cavity is defined in the housing, for containing the cam shaft. An intermediate channel is formed between the first and second housing cavities, for containing the support device, the intermediate channel including a pair of channel surfaces, opposed to one another, formed by machining, for guiding the support device. A black surface is formed on the support device in black dyeing.

Furthermore, a wire connector is disposed at a proximal end of the cam shaft, for coupling of a wire device for rotating the cam shaft.

The movable lens is constituted by first and second movable lenses. Furthermore, a first stationary lens is disposed on a distal side of the first and second movable lenses. A second stationary lens is disposed on a proximal side of the first and second movable lenses.

The support device is constituted by first and second support devices corresponding to respectively the first and second movable lenses, and the cam device is constituted by first and second cam devices corresponding to respectively the first and second support devices.

The channel surfaces are formed by machining a surface of the housing at first, masking a portion of the intermediate channel, and then dyeing the housing in black dyeing.

In one preferred embodiment, the channel surfaces are formed by dyeing the housing in black dyeing at first, and then machining a portion of the intermediate channel.

Furthermore, a lens holder holds the movable lens, the support device projecting from the lens holder. An anti-scatter device has a surface processed in black dyeing, contained in the first housing cavity, for covering the lens holder in a sleeve form, to prevent scatter of incident light.

The movable lens is constituted by first and second movable lenses, the anti-scatter device is constituted by first and second anti-scatter devices corresponding to the first and second movable lenses. Furthermore, an aperture stop plate is disposed on the first anti-scatter device and between the first and second movable lenses, for limiting a light flux from the first movable lens.

The cam device includes a cam groove formed in the cam shaft. A cam follower is formed with the support device, and engaged with the cam groove.

Also, a camera module for an endoscope is provided, and includes a lens system having at least one movable lens. A rotatable cam shaft is disposed to extend in parallel with an optical axis direction of the movable lens. A support device supports the movable lens on the cam shaft movably in the optical axis direction. A cam device is disposed between the cam shaft and the support device, for moving the movable lens in the optical axis direction in response to rotation of the camshaft. A housing is provided. A first housing cavity is defined in the housing, for containing the movable lens. A second housing cavity is defined in the housing, for containing the cam shaft. An intermediate channel is formed between the first and second housing cavities, for containing the support device, the intermediate channel including a pair of channel surfaces, opposed to one another, formed by machining, for guiding the support device. A black surface is formed on the support device in black dyeing. An image sensor receives image light to create an image. A prism directs the image light passed through the lens system toward the image sensor. A prism holder retains the prism on the housing in correspondence with the lens system. A signal cable is disposed to extend from the image sensor in a proximal direction. A cable holder is retained on the prism holder, for covering the signal cable at least partially.

Also, a lens unit for an endoscope is provided, and includes a movable lens. A rotatable cam shaft is disposed to extend in parallel with an optical axis direction of the movable lens. A support device supports the movable lens on the cam shaft movably in the optical axis direction. A cam device is disposed between the cam shaft and the support device, for moving the movable lens in the optical axis direction in response to rotation of the cam shaft. A housing is provided. A first housing cavity is defined in the housing, for containing the movable lens. A second housing cavity is defined in the housing, for containing the cam shaft. An intermediate channel is formed between the first and second housing cavities, for containing the support device. The intermediate channel includes a pair of first channel surfaces, disposed on a distal side in the optical axis direction, and opposed to one another. A pair of second channel surfaces are disposed at a proximal end of the first channel surfaces in the optical axis direction, opposed to one another at a surface distance smaller than a surface distance between the first channel surfaces, for guiding the support device.

The movable lens is constituted by first and second movable lenses, the support device is constituted by first and second support devices, the first support device corresponds to the first movable lens and is guided by the first channel surfaces, and the second support device corresponds to the second movable lens and is guided by the second channel surfaces.

Furthermore, a first stationary lens is disposed on a distal side of the first and second movable lenses. A second stationary lens is disposed on a proximal side of the first and second movable lenses.

Furthermore, first and second lens holders have a surface processed in black dyeing, for respectively holding the first and second movable lenses, the first and second support devices projecting from respectively the first and second lens holders. The first and second channel surfaces are formed by machining.

Furthermore, first and second anti-scatter devices have a surface processed in black dyeing, contained in the first housing cavity, for covering respectively the first and second lens holders in a sleeve form, to prevent scatter of incident light. An aperture stop plate is disposed on the first anti-scatter device and between the first and second movable lenses, for limiting a light flux from the first movable lens.

Furthermore, a wire connector is disposed at a proximal end of the cam shaft, for coupling of a wire device for rotating the cam shaft.

Also, a camera module for an endoscope is provided, and includes a lens system having at least one movable lens. A rotatable cam shaft is disposed to extend in parallel with an optical axis direction of the movable lens. A support device supports the movable lens on the cam shaft movably in the optical axis direction. A cam device is disposed between the cam shaft and the support device, for moving the movable lens in the optical axis direction in response to rotation of the camshaft. A housing is provided. A first housing cavity is defined in the housing, for containing the movable lens. A second housing cavity is defined in the housing, for containing the cam shaft. An intermediate channel is formed between the first and second housing cavities, for containing the support device. The intermediate channel includes a pair of first channel surfaces, disposed on a distal side in the optical axis direction, and opposed to one another, and a pair of second channel surfaces, disposed at a proximal end of the first channel surfaces in the optical axis direction, opposed to one another at a surface distance smaller than a surface distance between the first channel surfaces, for guiding the support device. An image sensor receives image light to create an image. A prism directs the image light passed through the lens system toward the image sensor. A prism holder retains the prism on the housing in correspondence with the lens system. A signal cable is disposed to extend from the image sensor in a proximal direction. A cable holder is retained on the prism holder, for covering the signal cable at least partially.

Accordingly, production can be efficiently performed by raising yield of an assembly of parts of the endoscope, because channel surfaces of the intermediate channel in the housing are formed by machining which is effective in raising precision of the parts to be assembled.

### BRIEF DESCRIPTION OF THE DRAWINGS

The above objects and advantages of the present invention will become more apparent from the following detailed description when read in connection with the accompanying drawings, in which:

FIG. 1 is an exploded perspective view illustrating a lens unit;

FIG. 2 is a perspective view illustrating a housing of the lens unit;

FIG. 3 is a vertical section illustrating the lens unit;

FIG. 4 is a vertical section illustrating a camera module;

FIG. 5 is a vertical section illustrating the camera module in a telephoto position;

FIG. 6 is a table illustrating features of preferred embodiment in comparison with a comparison example;

FIG. 7 is an exploded perspective view illustrating the camera module;

FIG. 8 is a perspective view illustrating the camera module;

FIG. 9 is an explanatory view illustrating an endoscope system;

FIG. 10 is a perspective view illustrating a head assembly of the endoscope;

FIG. 11 is a perspective view illustrating a housing of another preferred lens unit;

FIG. 12 is a vertical section illustrating the lens unit;

FIG. 13 is a vertical section illustrating a camera module;

FIG. 14 is a vertical section illustrating the camera module.

### DETAILED DESCRIPTION OF THE PREFERRED EMBODIMENT(S) OF THE PRESENT INVENTION

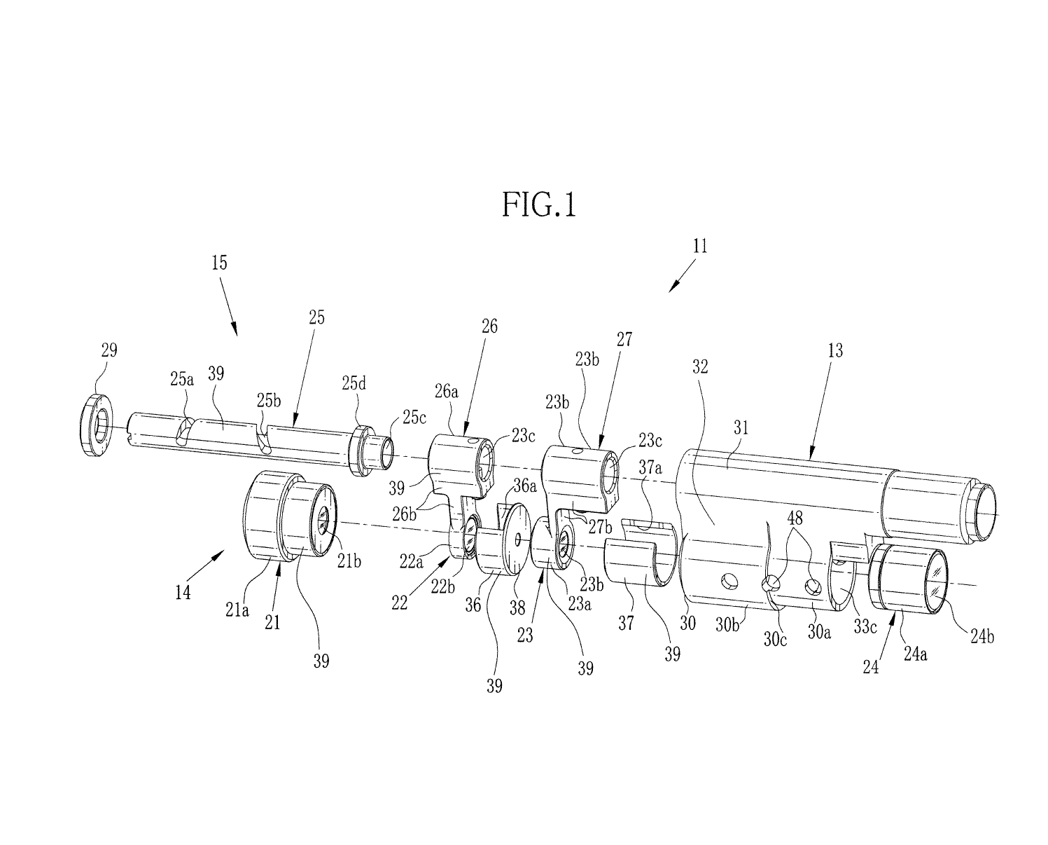

In FIGS. 1, 2 and 3, a lens unit 11 or lens assembly for imaging is illustrated. The lens unit 11 includes a housing 13, a lens system 14 and a lens moving mechanism 15.

The lens system 14 is constituted by a first stationary lens 21, a first movable lens 22, a second movable lens 23, and a second stationary lens 24. The first stationary lens 21 includes a lens holder 21a and a lens/lens group 21b (lens optics), which includes one or more lens elements and is positioned in the lens holder 21a. The first movable lens 22 includes a lens holder 22a and a lens/lens group 22b. The second movable lens 23 includes a lens holder 23a and a lens/lens group 23b. The second stationary lens 24 includes a lens holder 24a and a lens/lens group 24b.

The lens moving mechanism 15 includes a cam shaft 25, a first support device 26, and a second support device 27. The first and second support devices 26 and 27 are movable on the cam shaft 25 in an optical axis direction. The lens moving mechanism 15 moves the first and second movable lenses 22 and 23 in the optical axis direction for variable magnification by changing a focal length of the lens system 14.

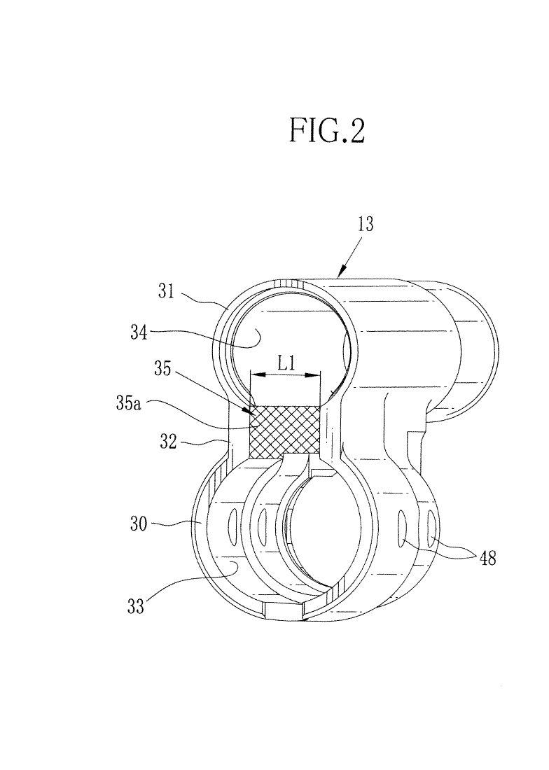

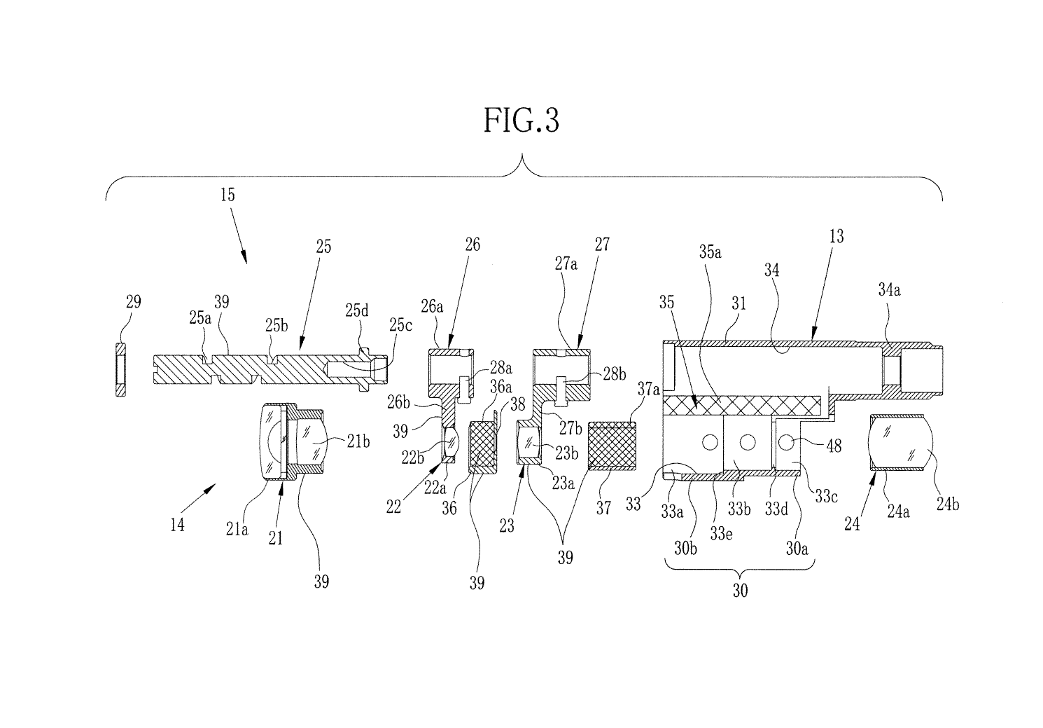

The housing 13 includes a first curved portion 30, a second curved portion 31, and a connection wall 32. The first and second curved portions 30 and 31 are sleeve portions arranged in a radial direction crosswise to the optical axis direction. The connection wall 32 connects the second curved portion 31 to the first curved portion 30. In FIG. 2, an outer diameter of the second curved portion 31 is smaller than that of the first curved portion 30 so that the housing 13 is in an 8-shape as viewed in the optical axis direction from a front side. A first housing cavity 33 is defined in the first curved portion 30, and contains the lens system 14. A second housing cavity 34 is defined in the second curved portion 31, and contains the lens moving mechanism 15. In FIG. 3, an internal abutment projection 34a projects from an inner surface of the second housing cavity 34. An intermediate channel 35 or slide channel is defined in the connection wall 32, and communicates between the first and second housing cavities 33 and 34.

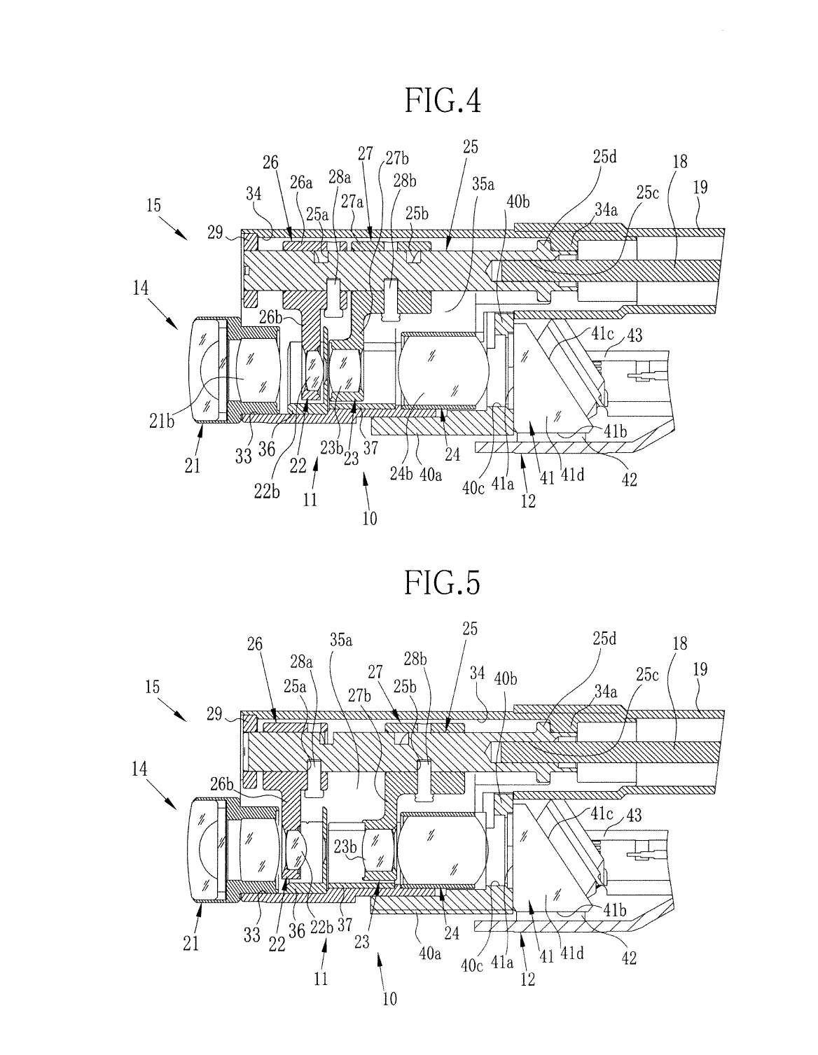

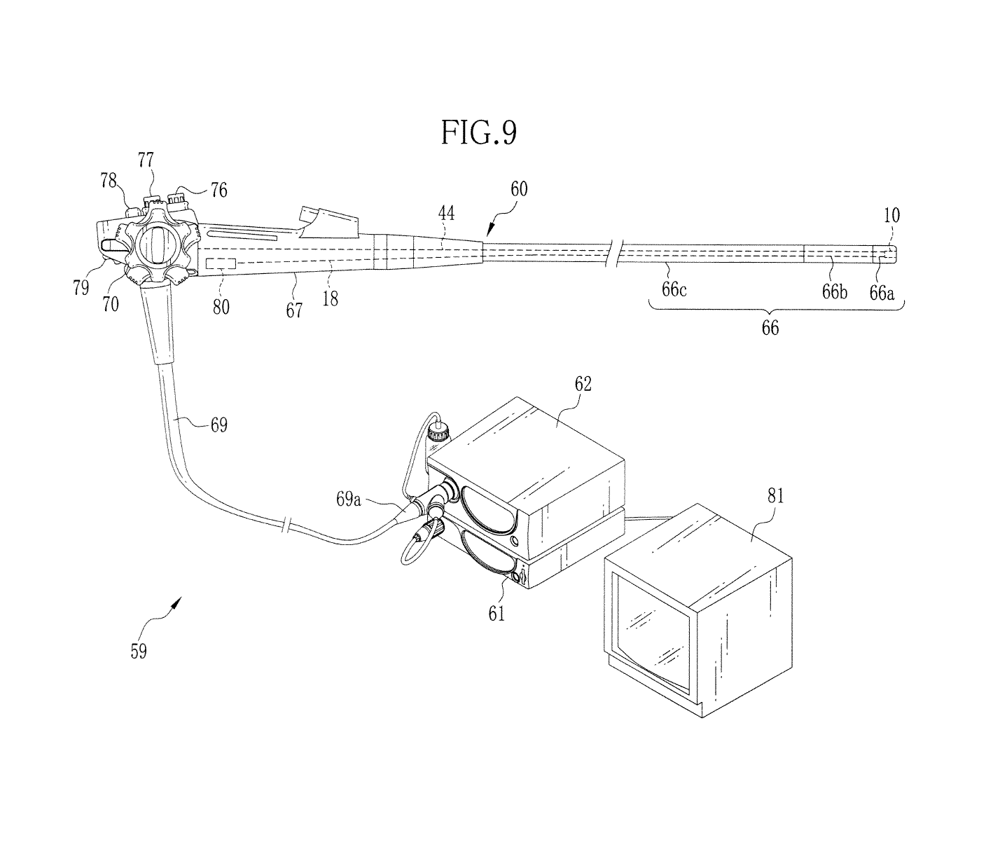

In FIGS. 1 and 3, the cam shaft 25 has a sufficiently large diameter, and includes cam grooves 25a and 25b, a wire hole 25c (wire connector) and an abutment flange 25d. The cam grooves 25a and 25b are disposed in a peripheral surface of the camshaft 25. The wire hole 25c is formed in a proximal end of the cam shaft 25. The abutment flange 25d is formed on the peripheral surface and near to the proximal end. In FIG. 4, a rotating wire 18 or wire device has a distal end portion fitted in the wire hole 25c. A protection tube 19 or sheath contains the rotating wire 18. An endoscope has a proximal handle 67, in which a motor 80 of FIG. 9 is incorporated. The rotating wire 18 is connected to the motor 80. A rocker switch button 79 or seesaw switch is disposed on the proximal handle 67. A controller (not shown) controls the motor 80 in response to a state of the rocker switch button 79, so that the motor 80 rotates in a forward or backward direction.

In FIGS. 1 and 3, a stationary ring 29 or end ring is disposed at a distal end of the camshaft 25. The stationary ring 29 keeps the cam shaft 25 rotatable smoothly in the second housing cavity 34 without an inclination in FIG. 4. The abutment flange 25d at the proximal end of the camshaft 25 is engaged with the abutment projection 34a so as to prevent the cam shaft 25 from dropping out of the second housing cavity 34.

In FIGS. 1 and 3, the first support device 26 is a single piece and includes a guide ring 26a and an arm portion 26b, which connects the guide ring 26a to the lens holder 22a. The second support device 27 is a single piece and includes a guide ring 27a and an arm portion 27b, which connects the guide ring 27a to the lens holder 23a. A first cam follower pin 28a projects from the guide ring 26a of the first support device 26, and is engaged with the cam groove 25a in the cam shaft 25 as a cam device. A second cam follower pin 28b projects from the guide ring 27a of the second support device 27, and is engaged with the cam groove 25b as a cam device.

When the motor 80 rotates the cam shaft 25 in one of the forward and backward directions (See FIG. 9), the cam shaft 25 operates for a shift in the support devices. The cam follower pins 28a and 28b are shifted to move the first and second support devices 26 and 27 in the optical axis direction in the housing 13.

In FIGS. 4 and 5, changeover of the focal length of the lens system 14 is illustrated. FIG. 4 illustrates a standard position. FIG. 5 illustrates a telephoto position. The first support device 26 in the telephoto position is shifted in the distal direction from its state of the standard position. The second support device 27 in the telephoto position is shifted in the proximal direction from its state of the standard position.

The first and second support devices 26 and 27 are caused to move smoothly in the optical axis direction by rotation of the cam shaft 25. To this end, particular parts of the first and second support devices 26 and 27 are selected for utilization by considering that a clearance space L1-t1 is in a range of 3 plus or minus 3 microns, wherein t1 is a thickness of the arm portions 26b and 27b, and L1 is a surface distance (channel width) between channel surfaces of the intermediate channel 35.

In FIG. 3, the first housing cavity 33 includes a first chamber 33a, a second chamber 33b and a third chamber 33c arranged in the proximal direction of the housing 13. The first chamber 33a contains the first stationary lens 21 and the first movable lens 22. The second chamber 33b contains the second movable lens 23. The third chamber 33c contains the second stationary lens 24. An internal annular projection 33d projects between the second and third chambers 33b and 33c. An inner diameter of the second chamber 33b is smaller than that of the first chamber 33a, but is equal to that of the third chamber 33c.

The housing 13 contains a first anti-scatter device 36 and a second anti-scatter device 37 of a curved shape or sleeves. The second anti-scatter device 37 is disposed inside the second chamber 33b. A side opening 37a is formed in the second anti-scatter device 37 and extends in the optical axis direction. The arm portion 27b of the second support device 27 is received in the side opening 37a. The lens holder 23a of the second support device 27 is received in the second anti-scatter device 37. An inner diameter of the second anti-scatter device 37 is slightly larger than an outer diameter of the lens holder 23a, which will not contact the inner surface of the second anti-scatter device 37 while slid in the optical axis direction.

The first anti-scatter device 36 is contained in the first chamber 33a. A side opening 36a is formed in the first anti-scatter device 36. There is an aperture stop plate 38 as a difference of the first anti-scatter device 36 from the second anti-scatter device 37. The aperture stop plate 38 is formed with a proximal end of the first anti-scatter device 36. A shoulder surface 33e with a step is defined between surfaces of the first and second chambers 33a and 33b, and regulates the proximal end of the first anti-scatter device 36 for positioning in the course of containment. The lens holder 22a of the first support device 26 moves inside the first anti-scatter device 36.

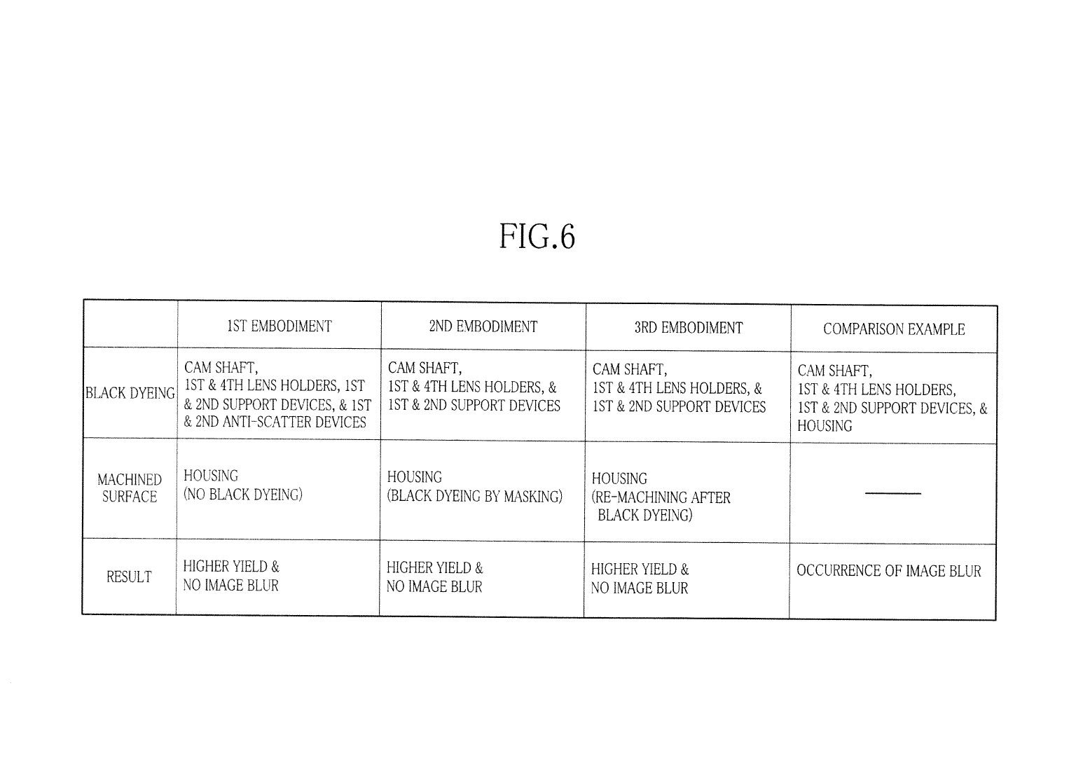

In FIG. 6, surfaces of various parts are dyed black to form a black layer 39, the parts including the lens holder 21a of the first stationary lens 21, the first support device 26 having the lens holder 22a of the first movable lens 22, the second support device 27 having the lens holder 23a of the second movable lens 23, the lens holder 24a of the second stationary lens 24, and the cam shaft 25. Each of the annular parts is characterized in having a pair of end openings and is not in a complicated form. The black layer 39 can be formed at a uniform thickness by the black dyeing. Precision in the size of the machining can be maintained. Various known methods for dyeing can be used. For example, chemical processing for dyeing by use of processing solution of dyeing can be used to form the black layer 39. In FIG. 3, portions of the black layer 39 are hatched for clarification inside the first and second anti-scatter devices 36 and 37. Also, the black layer 39 is provided on the lens holder 21a, the first and second support devices 26 and 27 and the lens holder 24a, but depicted simply without a thickness because of its very small thickness. It is possible not to dye the cam shaft 25 in the black dyeing, because the cam shaft 25 is structurally distant from the light path.

The housing 13 has a complicated shape with the first and second curved portions 30 and 31 arranged together and the intermediate channel 35 defined inside the connection wall 32 in a narrow form. The housing 13 has as small a size as 7×4×15 mm. The intermediate channel 35 has a pair of channel surfaces 35a. When the housing 13 is dyed black, insufficient flow of the processing solution for dyeing may occur on an inner surface of the housing 13, specifically on the channel surfaces 35a. The black layer 39 will have an insufficient thickness, will have only a partial area, or will have a larger thickness than expected. As a result, unevenness in the thickness of the black layer 39 occurs on the entirety of the channel surfaces 35a. Unevenness in the precision of the size occurs after the black dyeing even though the machining is effective in obtaining high precision. The number of combinations of parts in a tolerable range of the precision may decrease to lower the yield of the production.

In the present embodiment, there is no black dyeing of the housing 13, which is used in a state of machined surfaces. In a conventional structure of the housing 13, its inner surfaces are dyed black, so it is difficult to obtain high precision in the size between the first and second support devices 26 and 27 and the channel surfaces 35a for guiding those. However, in the present embodiment, the channel surfaces 35a of the housing 13 are machined surfaces. The first and second support devices 26 and 27 are coated with the black layer 39 at a uniform thickness because of great ease in the black dyeing on the outer surface. Therefore, the first and second support devices 26 and 27 can slide on the channel surfaces 35a smoothly in the optical axis direction reliably even with low torque of the cam shaft 25 in connection with the rotating wire 18. Also, the high precision in forming the housing 13 is maintained because of no black dyeing of the housing 13. Pairs of parts acceptable in the tolerable range can be increased. There is no drop in the yield of the production.

Furthermore, it is possible in another preferred embodiment of FIG. 6 to process surfaces of the housing 13 in black dyeing. A masking block (not shown) of rubber is prepared and is inserted in the intermediate channel 35. Processing solution is used but is prevented from contacting the channel surfaces 35a by the masking block, so as to maintain the precision of machining the channel surfaces 35a. In the embodiment, any one of various masking method can be used for the channel surfaces 35a of the intermediate channel 35. This is effective in omitting the first and second anti-scatter devices 36 and 37 because a black layer is formed on the housing 13. It is possible in the embodiment to simplify the structure of the lens unit, and to assemble parts of the lens unit with great ease.

Alternatively, it is possible in a third preferred embodiment to dye the housing 13 black entirely without masking, and then to machine the channel surfaces 35a by cutting for high precision. See the portion of FIG. 6 for this embodiment. This feature is effective in obtaining the high precision in the size because of the additional final machining. Although there is an increase in the number of the machining steps, the yield of the production can be increased. The first and second movable lenses 22 and 23 can be moved reliably even with a low torque.

FIG. 6 is a table illustrating the three preferred embodiments together with a comparison example. According to an experiment, the yield of the production was higher in any one of the embodiments than the comparison example. In the embodiments, the lens system was moved smoothly by use of the wire. In the comparison example, failure occurred in moving the lens system smoothly by use of the wire.

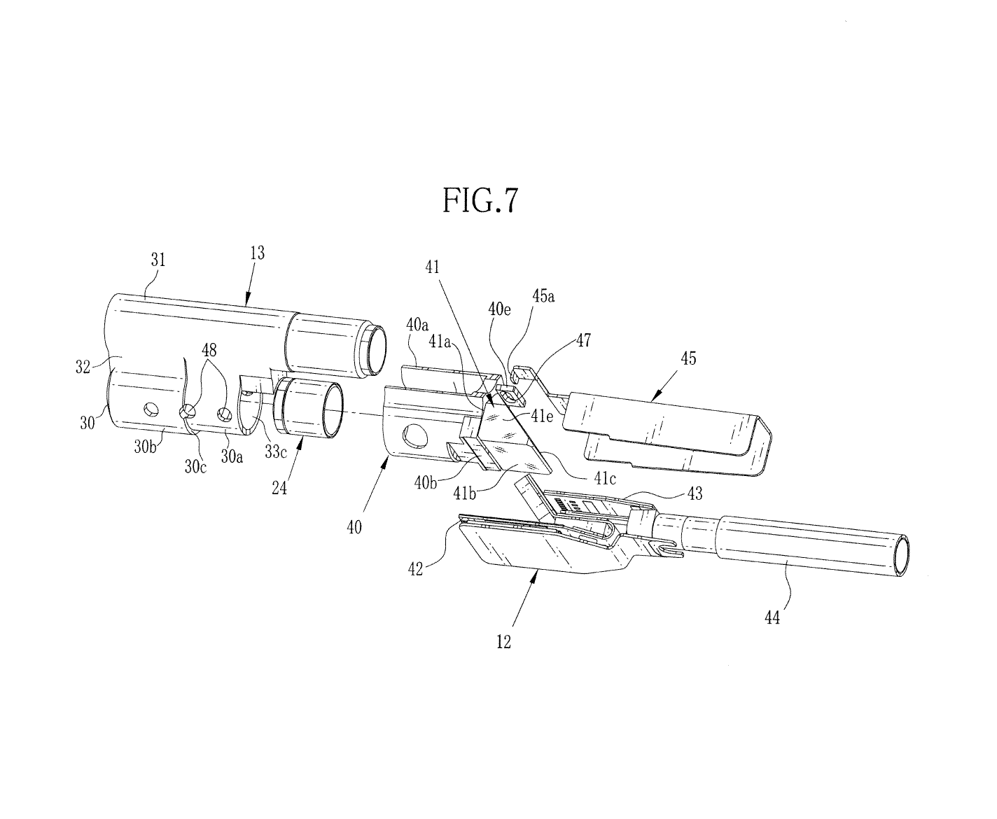

In FIG. 3, the second curved portion 31 extends longer than the first curved portion 30 because of containing the cam shaft 25. A distal surface of the second curved portion 31 is flush with that of the first curved portion 30. However, a proximal surface of the second curved portion 31 is disposed on a proximal side of that of the first curved portion 30. This difference in the proximal surfaces defines a space on the proximal side of the first curved portion 30. In FIG. 7, a camera module 10 is illustrated. A detection unit 12 for imaging is connected with the lens unit 11 by utilizing the space.

The first curved portion 30 of the housing 13 includes a large diameter wall 30b and a small diameter wall 30a on the proximal side of the large diameter wall 30b. A shoulder surface 30c with a step is formed between the large and small diameter walls 30a and 30b. The detection unit 12 has a prism holder 40. A holder housing 40a of the prism holder 40 is fitted on the outside of the small diameter wall 30a. A prism 41 is aligned with the first curved portion 30 on the proximal side, to construct the camera module 10 compactly by use of the space.

The detection unit 12 has the prism holder 40 and the prism 41, and includes a CCD image sensor 42, a circuit board 43, a signal cable 44 or transmission line, a cable holder 45 and sealant (not shown) for sealing those cable elements. Holes 48 are formed in the housing 13, and used suitably for injection of an adhesive agent or entry of screws for fastening the first and second anti-scatter devices 36 and 37 and the second stationary lens 24 to the inside of the first housing cavity 33.

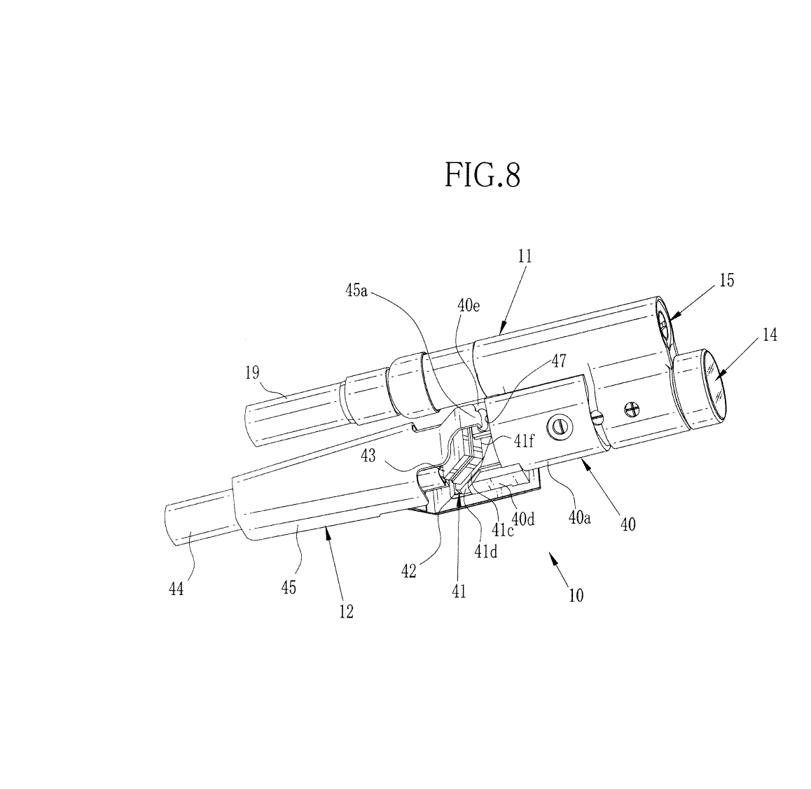

A holder frame 40b and the holder housing 40a are included in the prism holder 40. In FIG. 5, the prism 41 is a right angle prism, and includes an incident surface 41a, an exit surface 41b, a reflection surface 41c with an inclination, and lateral surfaces 41d. A holder opening 40c is formed in the holder frame 40b and receives light from the lens system 14. Positioning portions 40d and 40e are formed on a proximal end of the holder frame 40b. In FIG. 8, the positioning portion 40d contacts one of the lateral surfaces 41d of the prism 41. The prism 41 has a prism edge 41f defined between the incident surface 41a and the exit surface 41b intersecting perpendicularly. The positioning portion 40e contacts the prism edge 41f. The prism 41 can be positioned on the holder frame 40b by contact of the lateral surface 41d and the prism edge 41f with the positioning portions 40d and 40e.

The CCD 42 is attached to the exit surface 41b of the prism 41 by adhesive agent. The circuit board 43 for driving the CCD 42 is attached to an inclined surface of the prism 41 by adhesive agent. Signal lines and flexible wiring boards are combined with the CCD 42 and the circuit board 43. Ends of the signal cable 44 are connected to the circuit board 43. The signal cable 44 has signal lines and a shield layer covering the signal lines. Furthermore, an outer cable cover (cable jacket) covers the shield layer. Note that the circuit board 43 can be constituted by plural smaller circuit boards, which can be disposed suitably for the purpose.

A first end of the cable holder 45 is attached to the cable cover for the signal cable 44 by adhesive agent. A second end of the cable holder 45 has a retaining claw 45a in a bent shape. A retaining hole 47 is formed in the positioning portion 40e and receives engagement of the retaining claw 45a. Sealant (not shown), if required, is injected and hardened in gaps between the cable holder 45, the CCD 42 and the circuit board 43 for protecting signal lines covered by those. The cable holder 45, although formed in a plate form in the embodiment, can be a frame form and the like.

In FIG. 9, an electronic endoscope 60 is illustrated, in which the camera module 10 is incorporated. An endoscope system 59 is constituted by the endoscope 60, a processing apparatus 61 and a light source apparatus 62. The endoscope 60 includes an elongated tube 66 or guide tube, the proximal handle 67, a connection plug 69a and a universal cable 69. The elongated tube 66 is flexible for entry in a body cavity. The proximal handle 67 is disposed at a proximal end of the elongated tube 66 and operable manually. The connection plug 69a is used for connection to the processing apparatus 61 and the light source apparatus 62. The universal cable 69 extends between the proximal handle 67 and the connection plug 69a.

The elongated tube 66 includes a head assembly 66a or tip device, a steering device 66b and a flexible device 66c arranged in a proximal direction. The head assembly 66a includes an end shell of a rigid resin, and a head cap of a soft resin fitted on the end shell. A cover tube is fitted on outer surfaces of the end shell and the steering device 66b. The steering device 66b is a train of link elements which are connected with one another in a rotatable manner by pins, and is bendable by steering. Steering wheels 70 are disposed on the proximal handle 67, and rotated to bend the steering device 66b to the right or left or up or down. The head assembly 66a can be oriented in a desired direction in the body cavity for the camera module 10 to create an image of an object of interest in the body cavity. The flexible device 66c extends flexibly with a sufficient length between the proximal handle 67 and the steering device 66b.

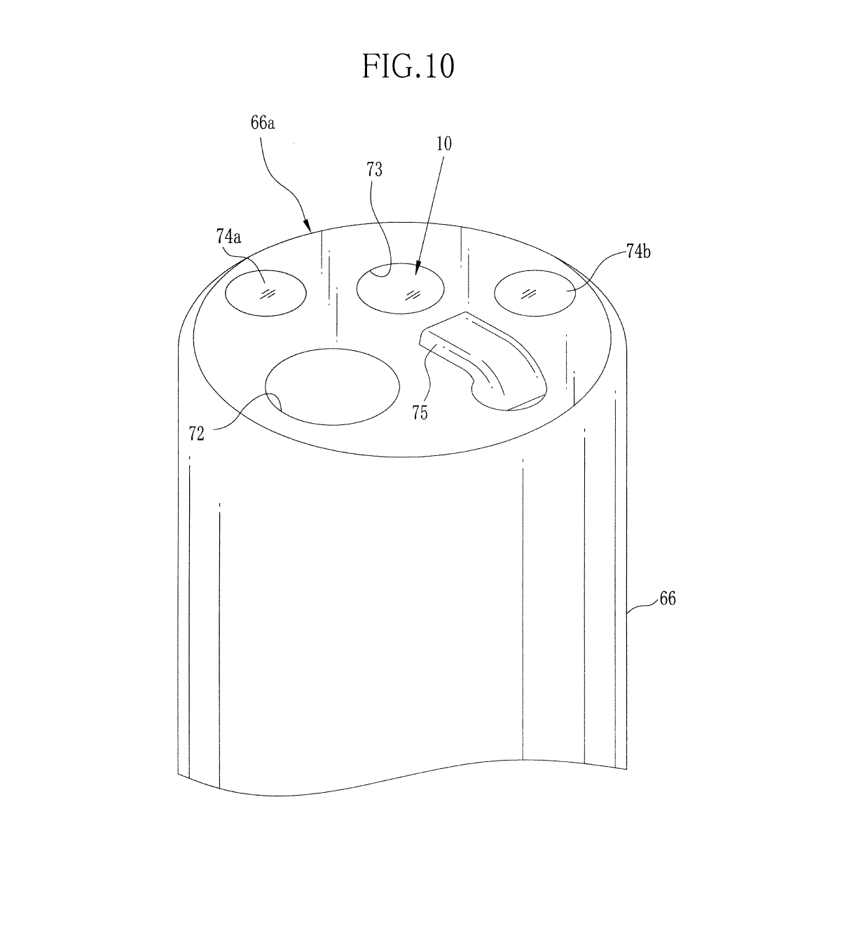

In FIG. 10, a distal surface of the head assembly 66a includes a distal instrument opening 72, an imaging window 73, lighting windows 74a and 74b and a nozzle spout of a fluid nozzle 75. Other elements may be disposed on the distal surface, such as a fluid nozzle for water jet and the like.

The proximal handle 67 includes a fluid supply button 76, a suction button 77, and an imaging button 78 in addition to the rocker switch button 79 and the steering wheels 70. The steering wheels 70 are rotated to steer the head assembly 66a of the elongated tube 66 to the right and left and up and down. The fluid supply button 76, when depressed, causes ejection of air or water through the fluid nozzle 75. The suction button 77, when depressed, causes suction of body fluid, partial tissue of target or the like of the body cavity through the distal instrument opening 72. The imaging button 78, when depressed, causes the camera module 10 to record an image of the object of interest in a form of a still image. The rocker switch button 79 is manipulated to rotate the motor 80 in one of the forward and backward directions. Rotations of the motor 80 are transmitted by the rotating wire 18 to the cam shaft 25, to zoom the lens system 14 at a magnification in a range between the standard imaging and telephoto imaging.

The processing apparatus 61 in electric connection with the light source apparatus 62 controls various elements in the endoscope system 59. The processing apparatus 61 supplies the endoscope 60 with the power through the universal cable 69 and the signal cable 44 in the elongated tube 66, and controls imaging of the camera module 10 in the head assembly 66a. Also, the processing apparatus 61 receives a signal from the camera module 10 through the signal cable 44, and creates image data after image processing of the signal. A monitor display panel 81 is connected to the processing apparatus 61. The display panel 81 displays an image according to the image data from the processing apparatus 61.

In the above embodiments, the first and second movable lenses 22 and 23 are used in the lens unit 11. However, the number of a movable lens 22 or 23 may be at least one. The first and second movable lenses 22 and 23 are moved for variable magnification in the above embodiments, but can be moved for focus adjustment. In the above embodiments, the rotating wire 18 is used for rotating the cam shaft 25. However, a motor can be used directly to drive the cam shaft 25. To this end, the motor can be contained in the head assembly in a specific type of endoscope. The image sensor is the CCD in the above embodiments, but can be a CMOS type. The endoscope is for medical use in the above embodiments, but can be for industrial use.

Furthermore, the image sensor in the endoscope may be incorporated in the handle. For this structure, a light guide device is used for guiding image light from the lens unit to the image sensor.

The color of the dyeing is black in the above embodiments, but can be other dark colors of a high absorption coefficient, such as dark gray and dark blue.

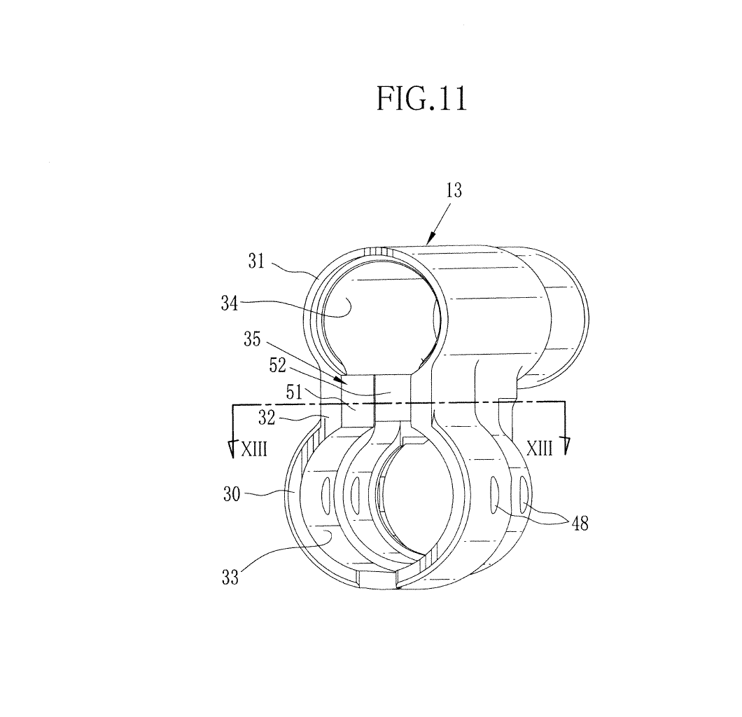

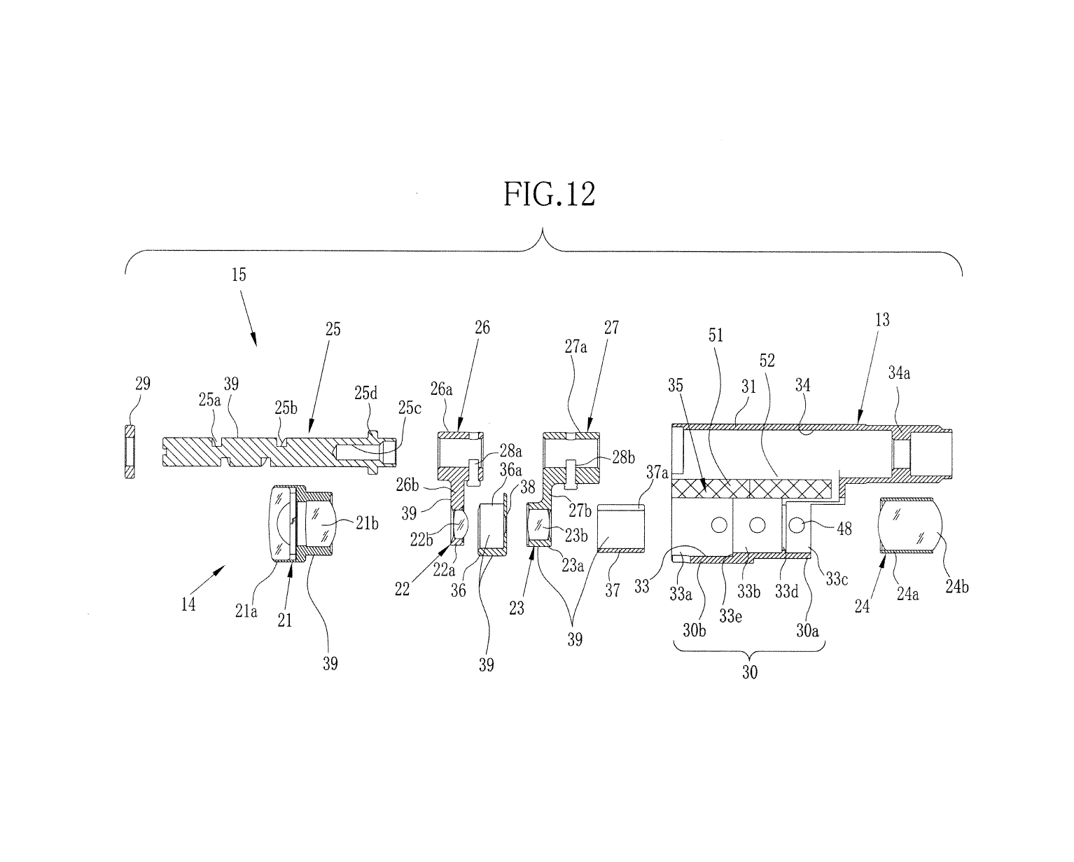

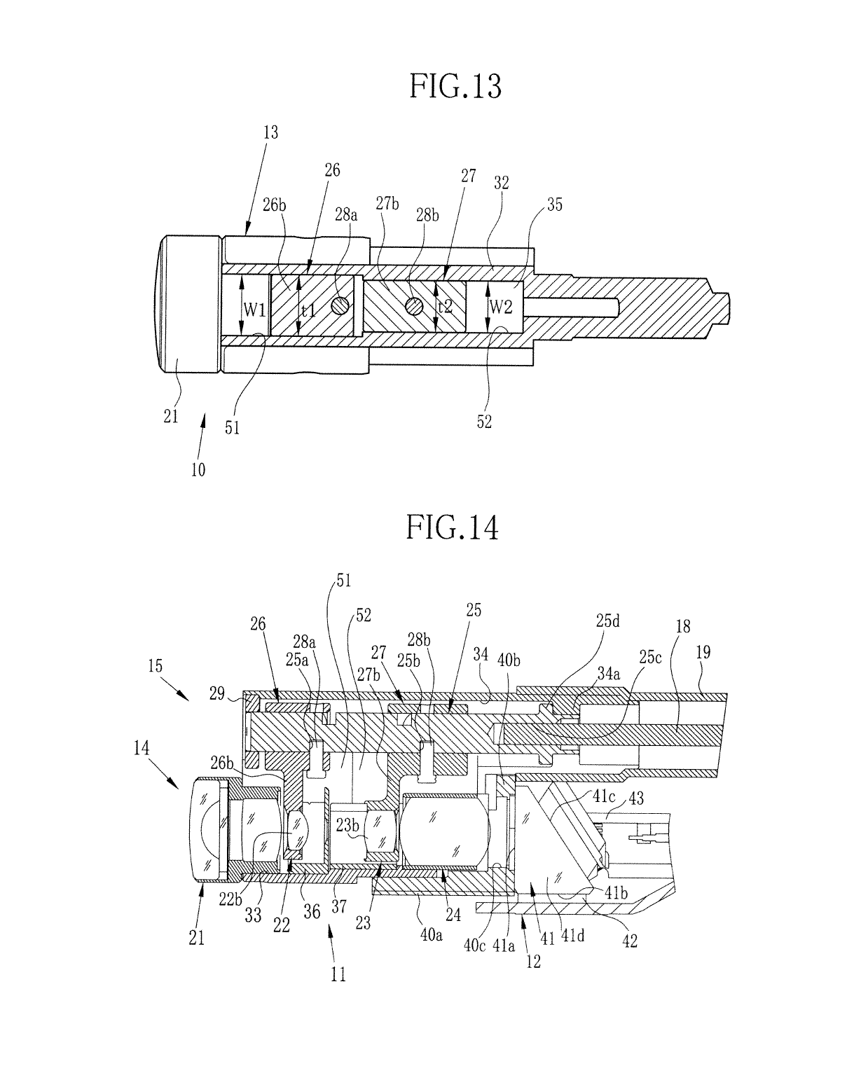

In FIGS. 11-14, a further preferred embodiment is illustrated, in which machining of the intermediate channel 35 is possible with greater ease by use of an end milling cutter. The intermediate channel 35 has first channel surfaces 51 and second channel surfaces 52 arranged in the proximal direction. In FIG. 13, the first channel surfaces 51 support the arm portion 26b of the first support device 26 in a narrow space for guiding the first support device 26. The second channel surfaces 52 support the arm portion 27b of the second support device 27 in a narrow space for guiding the second support device 27. Let W1 be a surface distance (channel width) between the first channel surfaces 51. Let W2 be a surface distance between the second channel surfaces 52. The first and second channel surfaces 51 and 52 are so formed as to satisfy a condition W2<W1.

In FIG. 13, the first and second support devices 26 and 27 are caused to move smoothly in the optical axis direction by rotation of the cam shaft 25. To this end, particular parts of the first and second support devices 26 and 27 are selected for utilization by considering that clearance spaces W1-t1 and W2-t2 are in a range of 3 plus or minus 3 microns, wherein t1 and t2 are respectively thicknesses of the arm portions 26b and 27b, and W1 and W2 are respectively surface distances (channel widths) between the first channel surfaces 51 and between the second channel surfaces 52.

In FIG. 13, the dual form with the first and second channel surfaces 51 and 52 is used. It is unnecessary to form a channel surface at one time in forming the intermediate channel 35 by machining of the housing 13. For example, the second channel surfaces 52 are formed after forming the first channel surfaces 51. Precision in forming the first and second channel surfaces 51 and 52 can be higher, because unwanted movement of an end milling cutter in the milling is reduced. Machining is possible because the regulation of the surface distances (channel widths) W1-t1 and W2-t2 in a tolerable range is performed. The yield of the production can be higher. The number of combinations of the first and second support devices 26 and 27 and the first and second channel surfaces 51 and 52 for guiding those can be higher than the structure in which channel surfaces are formed at one time by machining. The yield of production of the lens unit 11 can be increased.

As the second channel surfaces 52 are disposed with the first channel surfaces 51 in the shoulder form, walls of the second channel surfaces 52 can have a larger thickness than walls of the first channel surfaces 51. Thus, rigidity of the intermediate channel 35 can be high. Suitability of parts for machining can be improved according to the higher rigidity, to prevent drop in the yield of the production.

Although the first and second movable lenses 22 and 23 are used in the lens unit 11, the number of a movable lens 22 or 23 may be at least one. For this structure, the second channel surfaces 52 are used to slide and guide the support device 26 or 27.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A lens unit for an endoscope, comprising:
a movable lens;
a rotatable cam shaft disposed to extend in parallel with an optical axis direction of said movable lens;
a support device for supporting said movable lens on said cam shaft movably in said optical axis direction;
a cam device, disposed between said cam shaft and said support device, for moving said movable lens in said optical axis direction in response to rotation of said cam shaft;
a housing;
a first housing cavity, defined in said housing, for containing said movable lens;
a second housing cavity, defined in said housing, for containing said cam shaft;
an intermediate channel, formed between said first and second housing cavities, for containing said support device, said intermediate channel including a pair of channel surfaces, opposed to one another, formed by machining, for guiding said support device;
a black surface formed on said support device in black dyeing.

2. A lens unit as defined in claim 1, further comprising a wire connector, disposed at a proximal end of said cam shaft, for coupling of a wire device for rotating said cam shaft.

3. A lens unit as defined in claim 2, wherein said movable lens is constituted by first and second movable lenses;
further comprising:
a first stationary lens disposed on a distal side of said first and second movable lenses;
a second stationary lens disposed on a proximal side of said first and second movable lenses.

4. A lens unit as defined in claim 3, wherein said support device is constituted by first and second support devices corresponding to respectively said first and second movable lenses, and said cam device is constituted by first and second cam devices corresponding to respectively said first and second support devices.

5. A lens unit as defined in claim 1, wherein said channel surfaces are formed by machining a surface of said housing at first, masking a portion of said intermediate channel, and then dyeing said housing in black dyeing.

6. A lens unit as defined in claim 1, wherein said channel surfaces are formed by dyeing said housing in black dyeing at first, and then machining a portion of said intermediate channel.

7. A lens unit as defined in claim 1, further comprising:
a lens holder for holding said movable lens, said support device projecting from said lens holder;
an anti-scatter device, having a surface processed in black dyeing, contained in said first housing cavity, for covering said lens holder in a sleeve form, to prevent scatter of incident light.

8. A lens unit as defined in claim 7, wherein said movable lens is constituted by first and second movable lenses, said anti-scatter device is constituted by first and second anti-scatter devices corresponding to said first and second movable lenses;
further comprising an aperture stop plate, disposed on said first anti-scatter device and between said first and second movable lenses, for limiting a light flux from said first movable lens.

9. A lens unit as defined in claim 1, wherein said cam device includes:
a cam groove formed in said cam shaft;
a cam follower, formed with said support device, and engaged with said cam groove.

10. A camera module for an endoscope, comprising:
a lens system having at least one movable lens;
a rotatable cam shaft disposed to extend in parallel with an optical axis direction of said movable lens;
a support device for supporting said movable lens on said cam shaft movably in said optical axis direction;
a cam device, disposed between said cam shaft and said support device, for moving said movable lens in said optical axis direction in response to rotation of said cam shaft;
a housing;
a first housing cavity, defined in said housing, for containing said movable lens;
a second housing cavity, defined in said housing, for containing said cam shaft;
an intermediate channel, formed between said first and second housing cavities, for containing said support device, said intermediate channel including a pair of channel surfaces, opposed to one another, formed by machining, for guiding said support device;
a black surface formed on said support device in black dyeing;
an image sensor for receiving image light to create an image;
a prism for directing said image light passed through said lens system toward said image sensor;
a prism holder for retaining said prism on said housing in correspondence with said lens system;
a signal cable disposed to extend from said image sensor in a proximal direction;
a cable holder, retained on said prism holder, for covering said signal cable at least partially.

11. A lens unit for an endoscope, comprising:
a movable lens;
a rotatable cam shaft disposed to extend in parallel with an optical axis direction of said movable lens;
a support device for supporting said movable lens on said cam shaft movably in said optical axis direction;
a cam device, disposed between said cam shaft and said support device, for moving said movable lens in said optical axis direction in response to rotation of said cam shaft;
a housing;
a first housing cavity, defined in said housing, for containing said movable lens;
a second housing cavity, defined in said housing, for containing said cam shaft;
an intermediate channel, formed between said first and second housing cavities, for containing said support device;
said intermediate channel including:
a pair of first channel surfaces, disposed on a distal side in said optical axis direction, and opposed to one another;
a pair of second channel surfaces, disposed at a proximal end of said first channel surfaces in said optical axis direction, opposed to one another at a surface distance smaller than a surface distance between said first channel surfaces, for guiding said support device.

12. A lens unit as defined in claim 11, wherein said movable lens is constituted by first and second movable lenses, said support device is constituted by first and second support devices, said first support device corresponds to said first movable lens and is guided by said first channel surfaces, and said second support device corresponds to said second movable lens and is guided by said second channel surfaces.

13. A lens unit as defined in claim 12, further comprising:
a first stationary lens disposed on a distal side of said first and second movable lenses;
a second stationary lens disposed on a proximal side of said first and second movable lenses.

14. A lens unit as defined in claim 12, further comprising first and second lens holders, having a surface processed in black dyeing, for respectively holding said first and second movable lenses, said first and second support devices projecting from respectively said first and second lens holders;
wherein said first and second channel surfaces are formed by machining.

15. A lens unit as defined in claim 14, further comprising:
first and second anti-scatter devices, having a surface processed in black dyeing, contained in said first housing cavity, for covering respectively said first and second lens holders in a sleeve form, to prevent scatter of incident light;
an aperture stop plate, disposed on said first anti-scatter device and between said first and second movable lenses, for limiting a light flux from said first movable lens.

16. A lens unit as defined in claim 11, further comprising a wire connector, disposed at a proximal end of said cam shaft, for coupling of a wire device for rotating said cam shaft.

17. A camera module for an endoscope, comprising:
a lens system having at least one movable lens;
a rotatable cam shaft disposed to extend in parallel with an optical axis direction of said movable lens;
a support device for supporting said movable lens on said cam shaft movably in said optical axis direction;
a cam device, disposed between said cam shaft and said support device, for moving said movable lens in said optical axis direction in response to rotation of said cam shaft;
a housing;
a first housing cavity, defined in said housing, for containing said movable lens;
a second housing cavity, defined in said housing, for containing said cam shaft;
an intermediate channel, formed between said first and second housing cavities, for containing said support device;
said intermediate channel including a pair of first channel surfaces, disposed on a distal side in said optical axis direction, and opposed to one another, and a pair of second channel surfaces, disposed at a proximal end of said first channel surfaces in said optical axis direction, opposed to one another at a surface distance smaller than a surface distance between said first channel surfaces, for guiding said support device;
an image sensor for receiving image light to create an image;
a prism for directing said image light passed through said lens system toward said image sensor;
a prism holder for retaining said prism on said housing in correspondence with said lens system;
a signal cable disposed to extend from said image sensor in a proximal direction;
a cable holder, retained on said prism holder, for covering said signal cable at least partially.
